(19) United States
(12) Patent Application Publication
(10) Pub. No.: US 2007/0019577 A1
(43) Pub. Date: Jan. 25, 2007

(54) MOBILE TERMINAL AND DATA PROVIDING METHOD THEREOF

(75) Inventor: Jae-Young JANG, Anyang (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/459,466

(22) Filed: Jul. 24, 2006

(30) Foreign Application Priority Data
Jul. 23, 2005 (KR) 10-2005-0067086

(51) Int. Cl. G08C 17/00

(52) U.S. Cl. 370/311

(57) ABSTRACT

A data service system, and more particularly, a mobile terminal and a data providing method thereof can provide a data service by replacing only an RF card when a mobile communication network is changed. The mobile terminal includes an RF module that is attached/detached to/from the mobile terminal according to a mobile communication terminal and processes transmitted and received wireless data, a memory in which a program is stored so as to process the wireless data using the RF module, and a control unit that controls the RF module to process data or wireless communication.

### BACKGROUND OF THE INVENTION

1. Field of the Invention

The present invention relates to a data service system, and more particularly, to a mobile terminal and a data providing method thereof that can provide a data service by changing an RF card in response to a change in a mobile communication network.

2. Description of the Background Art

As a wireless communication field has been rapidly developed. As a wireless communication service is expanded, mobile terminals are widely used by the general public and thus it is possible to quickly transmit their ideas regardless of time and place. In addition, more various communication services have recently been provided due to competition between wireless communication service providers that provide wireless communication services. Further, in regard to a mobile communication network, a data speed is gradually increased by reviewing the existing network and efficiency of utilizing frequencies.

Currently, a mobile communication system that provides a data service, such as an Internet service, through a mobile communication network, such as a cellular network or a PCS network, may be, for example, a mobile communication system that provides a data service through the mobile communication network in a laptop that is connected to a mobile terminal.

FIG. 1 is an exemplary view of a mobile communication system that performs a data service in a mobile communication according to the related art.

As shown in FIG. 1, in the past, after a wired data cable 11 is connected between a mobile terminal 12 and a portable laptop 10, the mobile terminal 12 functions as a modem by using a connectivity program and a kit, such that a data service is implemented in the laptop 10.

Meanwhile, with respect to the data service, the users demand a higher data transmission speed and supplementary services. In order to meet the users' demands, mobile terminal vendors make efforts to improve performance of mobile terminals that serve as modems.

FIG. 2 is an exemplary view illustrating a development process of a mobile communication according to development of a mobile communication network in the related art.

As shown in FIG. 2, according to the development of the mobile communication network, the mobile terminals have been developed into GPRS (General Packet Radio Service) terminals, EDGE (Enhanced data service of GSM Evolution) terminals, UMTS (Universal Mobile Telecommunications System) terminals, HSDPA (High Speed Downlink Packet Access) mobile terminals, HSUPA (High speed Uplink Packet Access) mobile terminals, or the like.

However, as described above, the user stops using the existing mobile terminal and needs to purchase a new mobile terminal in order to be provided with higher data transmission and supplementary services according to a change in the mobile communication network.

### BRIEF DESCRIPTION OF THE INVENTION

Therefore, an object of the present invention is to provide a mobile terminal and a data providing method thereof capable of widening a selection range of a mobile terminal for a user and reducing additional costs caused by changing the mobile terminal by replacing only an RF module from the mobile terminal from which the RF module can be replaced in response to a change in a mobile communication network and such a mobile terminal to a mobile communication system.

Another object of the present invention is to provide a mobile terminal and a data providing method thereof capable of extending use time of batteries in the mobile terminal can be extended, and more efficiently providing data access environment in terms of space utilization as the RF module mounted into the mobile terminal is separated therefrom and connected to a portable laptop.

To achieve these and other advantages and in accordance with the purpose of the present invention, as embodied and broadly described herein, there is provided a mobile terminal including an RF module that is attached/detached to/from the mobile terminal according to a mobile communication network and processes transmitted and received wireless data, a memory in which a program is stored so as to process the wireless data using the RF module, and a control unit that controls the RF module so as to process data of wireless communication.

To achieve these and other advantages and in accordance with the purpose of the present invention, as embodied and broadly described herein, there is provided a data providing method in a mobile terminal, including changing an RF module in response to a change in a mobile communication network; determining whether information on the changed RF module is stored in the mobile terminal; and driving the RF module when the information on the changed RF module is stored in the mobile terminal so as to process wireless data by the mobile communication network.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view of a mobile communication system that performs a data service in a mobile communication according to the related art;

FIG. 2 is an exemplary view illustrating a development process of a mobile communication according to development of a mobile communication network in the related art;

FIG. 3 is a view showing the internal construction of a mobile terminal in accordance with the present invention;

FIG. 4 is an exemplary view illustrating a state where an RF card attachable to the mobile terminal according to the embodiment of the present invention is attached to a portable laptop;

FIG. 5 is an exemplary view showing improved data access environment using a replaceable RF card according to the present invention;

FIG. 6 is a flowchart illustrating a method of replacing an RF card from the mobile terminal in accordance with the present invention;

FIG. 7 is a flowchart illustrating a data providing method using a replaceable RF card in a portable laptop according to the present invention;

FIG. 8A is an exemplary view showing a method of changing software in accordance with the present invention; and

FIG. 8B is an exemplary view showing a method of changing software in the mobile terminal in accordance with the present invention.

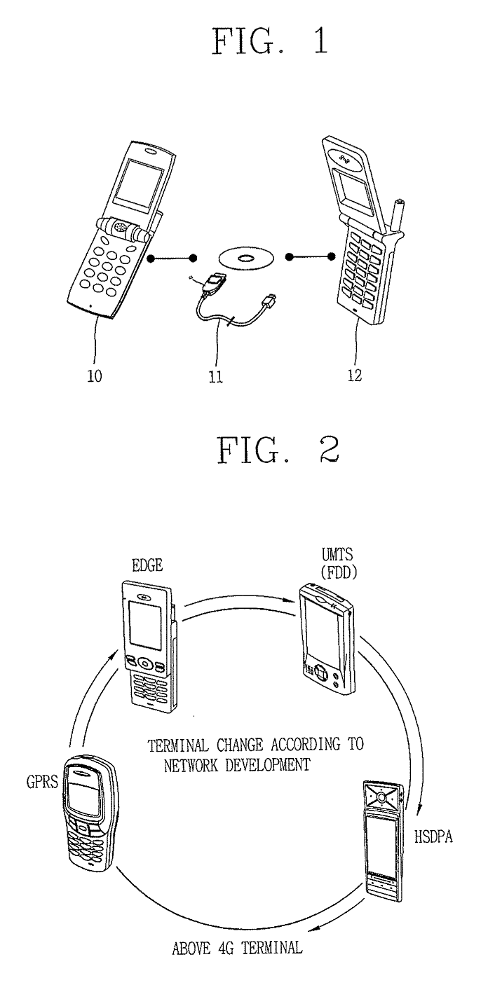

### DETAILED DESCRIPTION OF THE INVENTION

Reference will now be made in detail to the preferred embodiments of the present invention, examples of which are illustrated in the accompanying drawings.

It should be noted that parts necessary for the understanding of the operation and effects according to the present invention will hereinafter be described, and descriptions of the other parts will be omitted so as not to depart from an idea of the present invention.

In the description below, details of a mobile terminal and a data providing method thereof according to the present invention are presented for the general understanding of the present invention. The fact that the present invention can be easily implemented without the details or modifications of the details is well known to those skilled in the art.

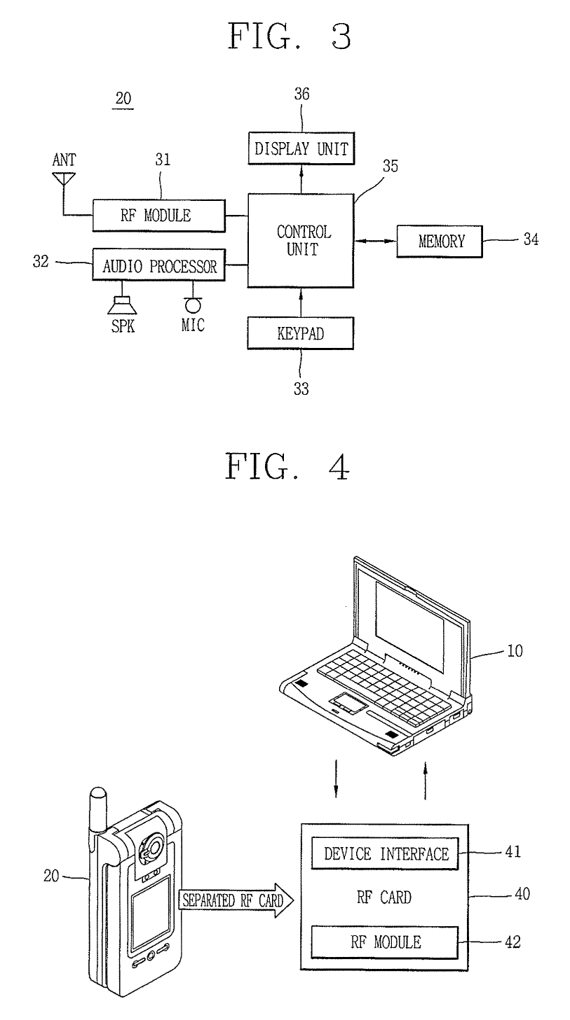

FIG. 3 is a view showing the internal construction of a mobile terminal in accordance with the present invention.

Referring to FIG. 3, an RF module 31 is attached/detached to/from a mobile terminal 20 according to a mobile communication network, and the RF module 31 processes wireless data that is received and transmitted. In addition, the RF module 31 includes an RF transmitter that upconverts and a frequency of a signal, which is transmitted, and amplifies the signal, and an RF receiver that low-noise amplifies a signal, which is received, and downconverts a frequency of the signal. The RF module 31 has an RF (radio frequency) unit that performs conversion between a high-frequency signal and an intermediate frequency, an IF (intermediate frequency) that performs conversion between an intermediate frequency and a baseband, a BBA (baseband analog) unit that performs conversion of an analog signal and a digital signal of a baseband, and a baseband modem unit that controls input and output signals of a display panel, a keypad, a microphone, and an earphone. Here, the RF module 31 may be mounted in the formed of an RF card. In addition, the RF module 31 is connected to the mobile terminal 29 through a device interface, and data exchanges therebetween.

An audio processor 32 plays a received audio signal that is output from a control unit 35 or transmits an audio signal, which is generated from a microphone MIC, to the RF module 31 through the control unit 35.

The keypad 33 has keys for inputting number and letter information and function keys for setting various kinds of functions.

A memory 34 includes a program memory or a data memory. The program memory stores programs that control the general operation of the mobile terminal. The program memory also stores programs that process wireless data by using the RF module 31. Here, the programs may be stored at the time of mass production of mobile terminals. In addition, the programs may be stored according to wired and wireless communication, such as communication using a wired data cable, infrared type communication or Bluetooth type communication, with a computer or a terminal that has downloaded a program which is supplied from a vendor through the Internet. Furthermore, the data memory temporarily stores data that is generated when the programs are executed. In addition, when the mobile terminal 20 is mounted with the RF module 31, the mobile terminal 20 automatically recognizes an RF card, which has been changed, and updates programs by an FOTA (Firmware Over The Air) method that wirelessly updates firmware of the mobile terminal.

The control unit 35 controls the generation operation of the mobile terminal. In addition, the control unit 35 includes a transmitter that encodes and modulates a signal that is transmitted through the RF module 31, and a receiver that demodulates and decodes the received signal. That is, the control unit 35 may include a modem and a codec. Here, the codec has a data codec that processes packet data and the like, and an audio codec that processes audio signals, such as a voice. Further, the control unit 35 recognizes a mobile communication network in which the RF module 31 provided according to the embodiment of the present invention can provide a service. According to a result of such recognition, the control unit 35 controls the general operation that wireless data is provided by programs of the corresponding mobile communication network. Furthermore, when programs corresponding to a mobile communication network in which the RF module 31 provides a service are not previously stored in the memory 34, the control unit 35 controls such that the corresponding programs should be downloaded and stored in the memory 34. Here, a management driver that performs a connection for exchanging data between the control unit 35 and the RF module 31 may be further included.

A display unit 36 displays messages, which are generated during program execution, under the control of the control unit 35. Further, the display unit 36 displays screen data according to information on the mobile communication network in which the RF module 31 can provide the service under the control of the control unit 35 according to the embodiment of the present invention. Here, the display unit 36 may use an LCD. In this case, the display unit 36 may include an LCD controller, a memory which can store image data, and an LCD display element. Here, when a touch screen type LCD is provided, the keypad 33 and the LCD are input units.

With the operation according to the above-described apparatus construction of the mobile terminal 20, when the mobile terminal 20 needs to be changed in response to the development of the mobile communication network, the mobile terminal 20 is not exchanged into a new one but only RF card including the RF module 31 is changed.

Thereafter, the mobile terminal 20 performs upgrade of software necessary for changing the RF card. Therefore, the user can widen a selection range of the mobile terminal 20 and reduce additional costs caused by changing the mobile terminal 20.

Alternatively, the RF card including the RF module 31 is separated from the mobile terminal 20 of the present invention and attached to the portable laptop 10.

FIG. 4 is an exemplary view illustrating a state where an RF card attachable to the mobile terminal according to the embodiment of the present invention is attached to a portable laptop.

Referring to FIG. 4, an RF card 40 can be separated from the mobile terminal 20 and shared by another external equipment, such as the portable laptop 10.

That is, the RF card 40 can easily be connected to external equipment, such as the portable laptop, a PC, and a PDA, through an interface 41 that is provided in the RF card 40. Therefore, it is possible to exchange data between various devices provided in the portable laptop 10 and the RF card 40. Further, the portable laptop 10 has an attachable and detachable unit (not shown) therein so as to mount the separated RF card 40.

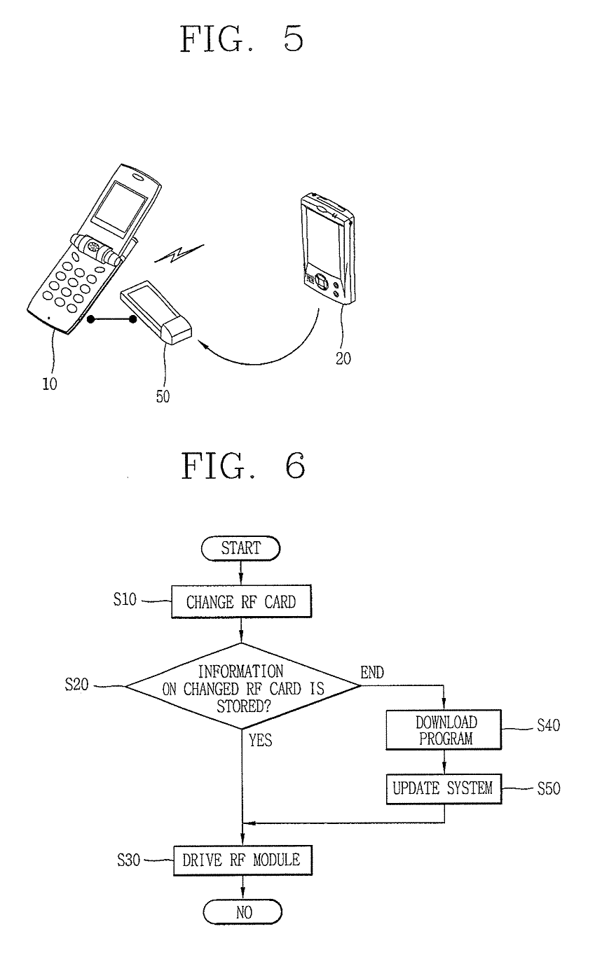

FIG. 5 is an exemplary view showing improved data access environment using a replaceable RF card according to the present invention.

Referring to FIG. 5, in the present invention, when a mobile communication network is changed in response to development of the mobile communication network, only the RF card 40 that is attached to the mobile terminal 20 is separated therefrom and attached to the portable laptop 10. At this time, the RF card 40 that is mounted into the portable laptop 10 includes an RF module and serves as a PCMCIA or an adaptor. Therefore, the RF card 40 serves as a cellular PC card (CPC) while coupled to the portable laptop 10. That is, a connection unit like a wired data cable is not needed between the related art portable laptop 10 and the mobile terminal. Thus, it is possible to provide efficient data access environment in terms of space utilization as compared with the related art. In addition, because the RF card 40 is directly mounted into the portable laptop 10, it is possible to more constantly manage power than the related art.

FIG. 6 is a flowchart illustrating a method of replacing an RF card from the mobile terminal in accordance with the present invention.

Referring to FIG. 6, a data providing method in the mobile terminal 20 having the attachable RF card 40 includes changing a type of the RF card 40 according to a change in a mobile communication network (S10), determining whether information on the changed RF card 40 is stored in the mobile terminal 20 (S20), driving an RF module 52 when the information on the changed RF card 50 is stored in the mobile terminal 20 (S30), downloading a program for update when a user is notified that the information on the changed RF card 40 is not stored in the mobile terminal 20 (S40), performing system update of the mobile terminal 20 by using the downloaded program (S50), and driving the RF module after the program is completely updated (S30).

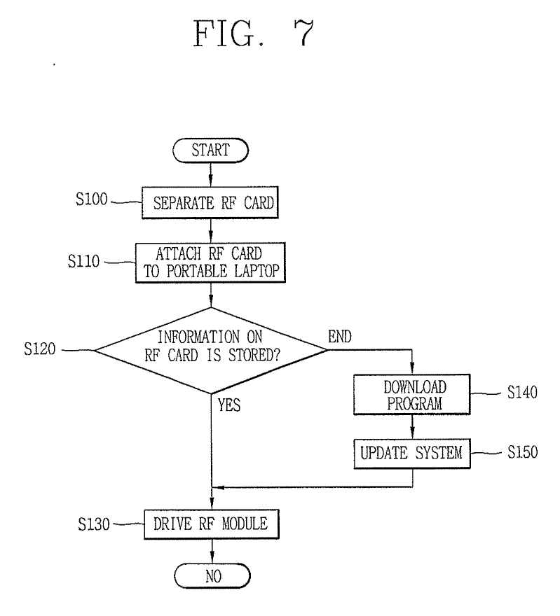

FIG. 7 is a flowchart illustrating a data providing method using a replaceable RF card in a portable laptop according to the present invention.

Referring to FIG. 7, a data serving method in the portable laptop 10 having the attachable RF card 40 includes separating the replaceable RF card 40 from the mobile terminal 20 (S100), attaching the RF card 40, which is separated from the mobile terminal 20, to the portable laptop 10 (S110), determining whether information on the RF card 50 is stored in the portable laptop 10 (S120), driving the RF card 40 when the information on the RF card 40 is stored in the portable laptop 10 (S130), downloading a program for update when a user is notified that the information on the RF card 40 is not stored in the portable laptop 10 (S140), performing system update of the portable laptop 10 using the downloaded program (S150), and driving the RF module 52 after the program is completely updated (S130).

Meanwhile, when the RF card 40 is mounted into the portable laptop 10, a method of providing an update program for performing data communication will now be described below with reference to the accompanying drawings.

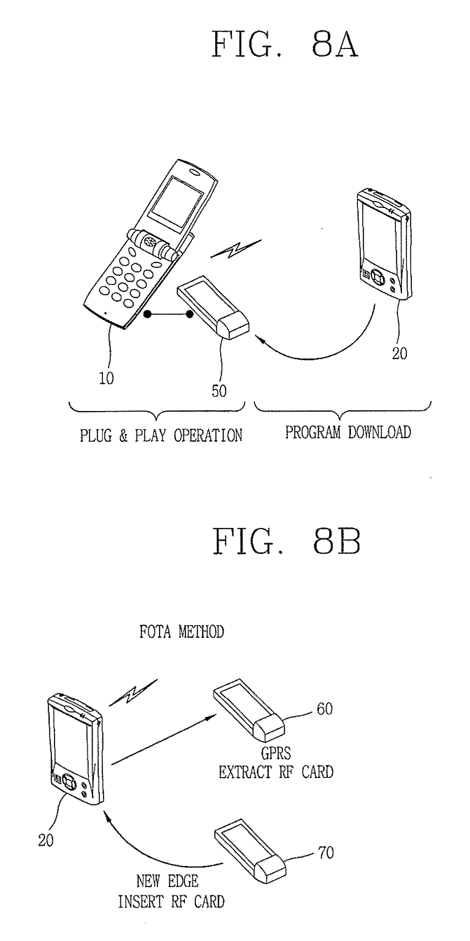

FIG. 8A is an exemplary view showing a method of changing software in accordance with the present invention. FIG. 8B is an exemplary view showing a method of changing software in the mobile terminal in accordance with the present invention.

Referring to FIGS. 8A and 8B, in the present invention, when the RF card 40 is changed in response to development of a mobile communication network, program update is performed so as to perform data communication in the mobile terminal 20 and the portable laptop 10.

The method of downloading a program for update so as to perform the data communication will be described in detail.

First, in order to download the program for update, the mobile terminal 20 performs wired and wireless communication, such as communication using a wired data cable, infrared type communication or Bluetooth type communication, with a computer or a terminal that has downloaded a program which is supplied from a vendor through the Internet. In addition, when the RF card is inserted into the mobile terminal 20, the mobile terminal 20 automatically recognizes the changed RF card 40 and updates the program by a FOTA (Firmware Over The Air) that wirelessly updates firmware of the mobile terminal 20.

Meanwhile, when the replaceable RF card 50 is inserted into the portable laptop 10, the portable laptop 10 automatically senses the inserted card according to Plug and Play operation and performs program update, such that convenient access environment to minimize user invention can be built.

As described in detail above, according to the present invention, when a mobile communication network is changed in response to development of the mobile communication network, replacement of an RF card only is applied to a mobile communication system. Therefore, a range in which a user selects a terminal is widened and additional costs caused by changing the terminal.

In addition, use time of batteries in the mobile terminal can be extended, and data access environment can be more efficiently provided in terms of space utilization.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
an RF module that is attached/detached to/from the mobile terminal according to a mobile communication network and processes transmitted and received wireless data;
a memory in which a program is stored so as to process the wireless data using the RF module; and
a control unit that controls the RF module so as to process data of wireless communication.

2. The mobile terminal of claim 1, further comprising:
a management driver that performs a connection for exchanging data between the RF module and the control unit.

3. The mobile terminal of claim 2,
wherein the RF module includes a device interface that is connected to the management driver and allows exchanging data therebetween.

4. The mobile terminal of claim 1,
wherein the RF module includes:
an RF (Radio Frequency) unit that performs conversion between a high-frequency signal and an intermediate frequency;
an IF (Intermediate Frequency) unit that performs conversion between the intermediate frequency and a baseband;
a BBA (Baseband Analog) unit that performs conversion of an analog signal and a digital signal of the baseband; and
a baseband modem unit that controls input and output signals of a display panel, a keypad, a microphone and an earphone.

5. The mobile terminal of claim 1,
wherein the control unit checks a type of the RF module and controls a mobile communication service corresponding to the checked type of the RF module when the RF module is replaced in response to the change in the mobile communication network.

6. The mobile terminal of claim 1,
wherein, when information on the RF module, which is replaced, is not stored in the memory, the control unit notifies a user that the information is not stored in the memory, performs system update of the mobile terminal by downloading a program for update, and after the update is completed, controls such that a mobile communication service using the changed RF module is performed.

7. The mobile terminal of claim 1,
wherein the program to process the wireless data is stored in the memory according to wired and wireless communications, such as communication using a wired data cable, infrared type communication, or Bluetooth type communication, with a computer or a terminal that has downloaded a program which is supplied from a vendor through the Internet.

8. A data providing method in a mobile terminal, comprising:
changing a type of an RF card in response to a change in a mobile communication network;
determining whether information on the changed RF card is stored in the mobile terminal; and
driving an RF module when the information on the changed RF card is stored in the mobile terminal.

9. The data providing method of claim 8, further comprising:
notifying, when the information on the changed RF card is not stored in the mobile terminal, a user that the information is not stored in the mobile terminal, and downloading a program for update;
performing system update of the mobile terminal by using the downloaded program; and
driving the RF module after the program is completely updated.

10. The data providing method of claim 9,
wherein the program update is performed by wired and wireless communications, such as communication using a wired data cable, infrared type communication, or Bluetooth type communication, with a computer or a terminal that downloads a program supplied from a vendor through the Internet.

11. The data providing method of claim 8,
wherein in the system update of the mobile terminal, a program can be updated by automatically recognizing the changed RF card by an FOTA method.
